(19) United States
(12) Patent Application Publication
(10) Pub. No.: US 2011/0085833 A1
(43) Pub. Date: Apr. 14, 2011

(54) FIXING DEVICE AND IMAGE FORMING APPARATUS

(76) Inventor: Hiroshi MATSUMOTO, Tokyo (JP)

(21) Appl. No.: 12/899,391

(22) Filed: Oct. 6, 2010

(30) Foreign Application Priority Data
Oct. 8, 2009 (JP) 2009-234008

(51) Int. Cl. G03G 15/20

(52) U.S. Cl. 399/329

(57) ABSTRACT

Disclosed is a fixing device including: a heating section; a pressure contact section to form a nip section with the heating device and to pressure a sheet so that the sheet contacts with the heating section; and a pressurizing section to add a pressurizing force to the sheet through the pressure contact section and to make the nip section be formed between the heating section and the pressure contact section; wherein the pressurizing section adds the higher pressurizing force to an upstream portion and a downstream portion of the nip section than the pressurizing force added to a central portion of the nip section in a sheet conveying direction, and adds the higher pressurizing force to the downstream portion than the pressurizing force added to the upstream portion.

### BACKGROUND

1. Field of the Invention

The present invention relates to a fixing device and an image forming apparatus.

2. Description of Related Art

Generally, in an electrophotographic image forming apparatus, a surface of an image carrier such as a photoconductive drum is charged to a predetermined potential, and image exposure is performed thereon to form an electrostatic latent image. Then, the latent image on the surface of the photoconductive drum is developed with developer (toner) by a developing member to be visualized as a toner image. The obtained toner image is transferred onto a sheet which has been conveyed to the photoconductive drum, the sheet which supports the toner image thereon is conveyed to a fixing device, and an unfixed toner image on the sheet is fixed by the fixing device so that a print image is obtained on the sheet.

The fixing device of the image forming apparatus is equipped with a heating section (heating roller) and a pressure contact section which is pressured to contact with the heating section to form a nip section. The heating section and the pressure contact section apply heat and pressure to the unfixed toner image on the sheet while the sheet is nipped by the nip section and conveyed, so that the toner image is fusion-fixed on the sheet.

Because of colorization and a demand for increasing a speed of the image forming apparatus of recently, making a length (nip width) of the nip section in a sheet conveying direction longer is required for making heat addition and pressure addition to the unfixed toner image more efficient. Thus, a fixing device of a belt-nip system has been adopted.

As the fixing device of the belt-nip system, for example, there has been disclosed a fixing device equipped with a heating section, and a pressure contact section which is pressured to contact with the heating section to form a nip section, wherein at least one of the heating and pressure contact sections includes an endless fixing belt and a pressing member to press the fixing belt from an inner periphery surface side so as to be contacted with the nip section, in Japanese Patent Application Laid-open Publication No. 2009-69585 and Japanese Patent Application Laid-open Publication No. 2009-69750.

Since the abovementioned fixing device of the belt-nip system has a configuration to press the fixing belt to the heating roller by the pressing member, the longer nip width results in more uneveness of sheet conveying speed in the nip section. Thus, there has been a problem that a sheet behavior becomes unstable so that the potentials of image misalignment and/or sheet wrinkles are increased.

### SUMMARY

The present invention was achieved in view of the aforesaid problems, and the object of the present invention is to prevent image failures from occurring in the nip section so as to improve fixing accuracy.

In order to solve at least one of the aforesaid problems, according to one aspect of the present invention, there is provided a fixing device including: a heating section; a pressure contact section to form a nip section with the heating device and to pressure a sheet so that the sheet contacts with the heating section; and a pressurizing section to add a pressurizing force to the sheet through the pressure contact section and to make the nip section be formed between the heating section and the pressure contact section; wherein the pressurizing section adds the higher pressurizing force to an upstream portion and a downstream portion of the nip section than the pressurizing force added to a central portion of the nip section in a sheet conveying direction, and adds the higher pressurizing force to the downstream portion than the pressurizing force added to the upstream portion.

In order to solve at least one of the aforesaid problems, according to one aspect of the present invention, there is provided an image forming apparatus including: an image forming section to form a toner image on an image carrier with a toner; a sheet conveying section to convey a sheet; a transferring section to transfer the toner image on the image carrier on the sheet conveyed by the sheet conveying section; and a fixing device to fix the toner image transferred on the sheet, wherein the fixing device including: a heating section; a pressure contact section to form a nip section with the heating device and to pressure the sheet so that the sheet contacts with the heating section; and a pressurizing section to add a pressurizing force to the sheet through the pressure contact section and to make the nip section be formed between the heating section and the pressure contact section, and the pressurizing section adds the higher pressurizing force to an upstream portion and a downstream portion of the nip section than the pressurizing force added to a central portion of the nip section in a sheet conveying direction, and adds the higher pressurizing force to the downstream portion than the pressurizing force added to the upstream portion.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein:

FIG. 1 is a schematic configuration diagram of an image forming apparatus according to this embodiment;

FIG. 2 is a schematic diagram of a fixing device;

FIG. 3A is a schematic configuration diagram of an example of a pressurizing section in which a third pad is provided with respect to upstream and central portions of a nip section in a sheet conveying direction;

FIG. 3B is a schematic configuration diagram of an example of the pressurizing section in which a member layer composed of a second pad is provided with respect to the upstream portion, and the third pad is provided with respect to the central portion, in the nip section in a sheet conveying direction;

FIG. 3C is a schematic configuration diagram of an example of the pressurizing section in which a member layer composed of the first pad is provided with respect to the upstream portion, and the third pad is provided with respect to the central portion, in the nip section in the sheet conveying direction;

FIG. 3D is a schematic configuration diagram of an example of the pressurizing section in which a member layer composed of the first and second pads is provided with respect to the upstream portion, and the third pad is provided with respect to the central portion, in the nip section in the sheet conveying direction;

FIG. 3E is a schematic configuration diagram of an example of the pressurizing section in which a member layer composed of the first and second pads is provided with respect to the upstream portion, and the third pad is provided with respect to the central portion, in the nip section in the sheet conveying direction;

FIG. 3F is a schematic configuration diagram of an example of the pressurizing section of FIG. 3E in which a thickness of the first pad 243b1 before a pressurizing force is applied by a compression spring is 1.5 [mm], and a thickness of the member layer is 3.5 [mm]; and

FIG. 4 is a diagram of distributions in the nip sections of the fixing devices respectively equipped with the pressurizing sections shown in FIGS. 3A-3F.

### DETAILED DESCRIPTION OF THE PREFERRED EMBODIMENT

Hereinafter the embodiment of the present invention will be described in detail with reference to the drawings.

Firstly, a configuration will be explained.

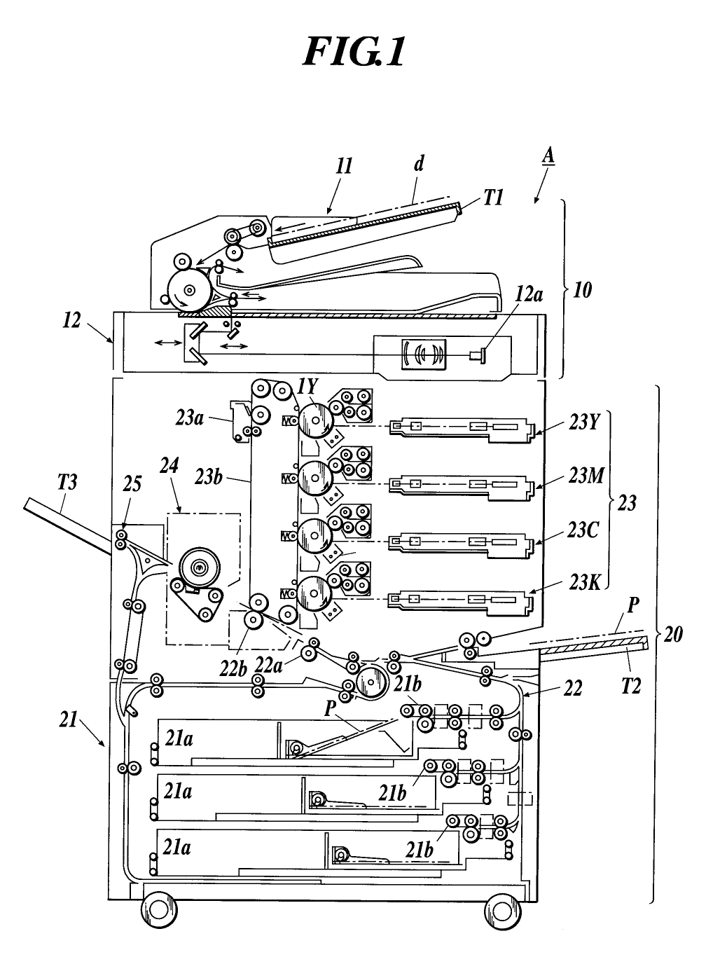

FIG. 1 shows a schematic configuration diagram of an image forming apparatus A according to the embodiment.

As shown in FIG. 1, an image forming apparatus A is configured to have functions including a copying function to read an image from a document to form a read image on a sheet P to output it, and a printing function to receive page data including image data and a job including image forming condition for each pieces of image data from an external device or the like to form the image on the sheet P based on the received job to output it. As shown in FIG. 1, the image forming apparatus A is equipped with an image reading section 10, a printing section 20, and so on.

The image reading section 10 is equipped with an automatic document sheet feeding section 11 called as Auto Document Feeder (ADF), and a reading section 12. The automatic document sheet feeding section 11 is provided at a top of a body of the image forming apparatus A. The automatic document sheet feeding section 11 includes a plurality of conveying rollers, and conveys a document d placed on a document tray T1 onto a slit glass as a read surface of the reading section 12.

The reading section 12 includes a light source, lens, contact glass, scanner including an image sensor 12a, and so on. The reading section 12 reads the image on the document by producing an image of light reflected on the document d to perform photoelectric conversion. The reading section 12 creates an image signal (analog signal) by the photoelectric conversion, and performs analog-digital conversion with respect to the image signal to create image data as a digital signal. The image used herein includes not only image data such as graphics and photographs, but text data such as characters and symbols.

The image data created by the image reading section 10 is output to an image processing section (not shown), and after performing various image processings, the image data is output to a printing section 20 or an image memory (not shown).

The printing section 20 includes a sheet feeding section 21, a fed sheet conveying section 22, an image forming section 23, a fixing section 24, and a discharging section 25.

The sheet feeding section 21 includes a plurality of feeding trays 21a, feeding mechanisms 21b, a manual feeding tray T2, and so on. The respective feeding trays 21a store various kinds of sheets P such as standard sheets, special sheets, and insertion sheets, which sheets are identified based on comparative weight, size, or the like of the sheet for each of the feeding trays 21a, and stored per each of previously set kinds. Each of the feeding mechanisms 21b starts to convey each sheet P stored in each of the feeding trays 21a, from the top of the sheets P, toward the fed sheet conveying section 22. On the manual feeding tray T2, various kinds of sheets P can be loaded depending on needs of a user. Feeding rollers start to convey each sheet P loaded on the manual feeding tray T2, from the top of the sheets P, toward the fed sheet conveying section 22.

The fed sheet conveying section 22 conveys the sheets P which have been conveyed from the feeding trays 21a or the manual feeing tray T2 to second transfer rollers 22b though a plurality of intermediate rollers, resist rollers 22a, and the so on. The fed sheet conveying section 22 also conveys the sheet P whose single side has been already image-formed to a both-side conveying path with a conveying path switching plate, and conveys the sheet P again to the second transfer rollers 22b through the intermediate rollers and resist rollers 22a. The second transfer rollers 22b correctively transfer on the sheet P the toner image which has been transferred on an intermediate transfer belt 23b to be hereinafter described.

The image forming section 23 is equipped with; image forming sections 23Y, 23M, 23C and 23K for respective colors, which can be filled with respective toners of different colors, for forming an image with a maximum of four colors (yellow (Y), magenta (M), cyan (C), and black (B)); a cleaning section 23a; and the intermediate transfer belt 23b.

The image forming section 23Y includes a charging device, an exposing device, a developing device, a first transfer roller, and a cleaning device, which are placed around a photoconductive drum as an image carrier to form an image of yellow (Y).

Concretely, the photoconductive drum charged with the charging device is irradiated with light from the exposing device, which light has been modulated depending on the image data of yellow (Y), so that an electrostatic latent image is formed. The developing device is filled with a toner of yellow (Y) to which an external additive has been added. The developing device makes the toner adhere to a surface of the photoconductive drum on which the electrostatic latent image is formed so as to develop the image. While the photoconductive drum to which the toner has been adhered by the developing device rotates at a certain speed, the toner is transferred to the intermediate transfer belt at a transfer position where the first transfer roller is placed. After the toner is transferred to the intermediate transfer belt 23b, the cleaning device removes residual charge, residual toner, and the like, on the surface of the photoconductive drum.

The image forming sections 23M, 23C and 23K have similar configurations to that of the image forming section 23Y, and form the image of magenta (M), cyan (C), and black (K) respectively.

The intermediate transfer belt 23b is a semiconductor endless belt wrapped around a plurality of rollers so as to be rotatably supported, and is rotationally driven with rotation of the rollers.

The intermediate transfer belt 23b is pressed against the respective photoconductive drums by respective first transfer rollers of the image forming sections 23Y, 23M, 23C and 23K. By this, the toners of respective colors which have been developed on the surface of the respective photoconductive drums are transferred to the intermediate transfer belt 23b at the transfer positions by the first transfer rollers so that the toners are superimposed sequentially. Then, the toners of yellow, magenta, cyan and black are collectively transferred to the sheet at the transfer position by the second transfer roller 22b. The intermediate transfer belt 23b makes the sheet P separate therefrom by curvature separation and/or electro separation, and the cleaning section 23a removes the residual toners.

The fixing device 24 is equipped with a heating roller, a fixing belt, a pressurizing section, and so on, and heat-and-pressure-fixes the toner image which has been transferred on the sheet with the nip section formed between the healing roller and the fixing belt.

The sheet P on which the toner image has been fixed is grasped between sheet exit rollers of the discharging section 25 to be discharged from a discharging port to a sheet output tray T3.

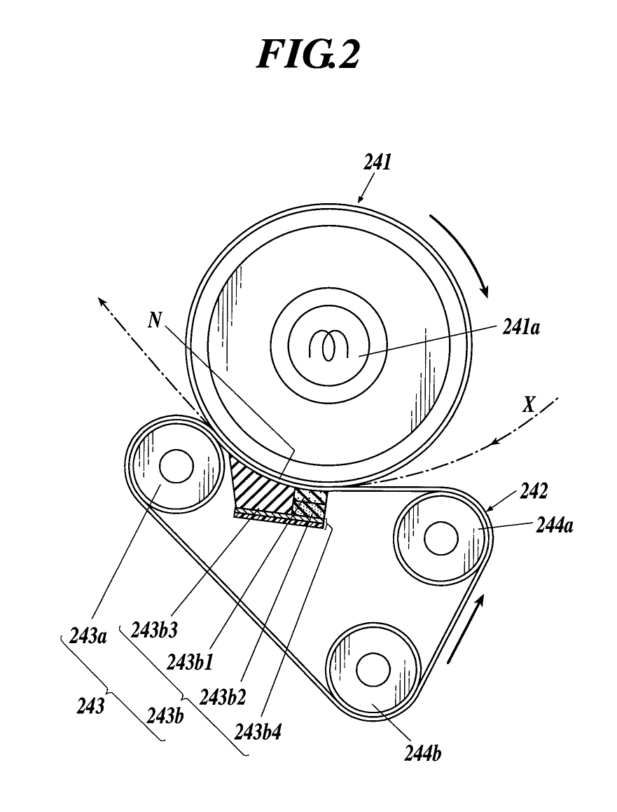

FIG. 2 shows a schematic diagram of the fixing device 24.

The fixing device 24 shown in FIG. 2 uses a belt nip system, and includes a heating roller 241, a fixing belt 242, and a pressurizing section 243.

The heating roller 241 houses therein a halogen heater 241a as a heating source. The heating roller 241 is composed of: a cylindrical cored bar formed from aluminum, iron, alloy, and the like; an elastic layer covering the cylindrical cored bar and being composed of an HTV silicon rubber having high heat-resistance; and a release layer covering the elastic layer and being composed of fluorine resin such as a perfluoro (alkyl vinyl ether) (PFA) and poly (tetra-fluoro ethylene) (PTFE), and functions as a heating section.

The fixing belt 242 is an endless belt wrapped around a plurality of rollers of: a roller 244a nearest to the upstream portion of the nip section N in the sheet conveying direction X; a pressurizing roller 243a provided at a position corresponding to the downstream portion of the nip section N; a roller 244b supporting the fixing belt 242; and the like, along a part of periphery of each roller, and is rotatably supported. The fixing belt 242 is rotationally driven with rotation of the rollers. The fixing belt 242 forms the nip section N by being abutted a periphery surface of the heating roller 241, and functions as a pressure contact section to pressure the sheet so that the sheet contacts with the heating roller 241.

The fixing belt 242 is composed of: a base substrate formed of a heat-resistant elastic resin such as polyimide; an elastic layer such as silicon rubber layer to cover an outer surface of the base substrate; and a release layer composed of fluorine resin such as the PFA and PTFE to cover the elastic layer.

The pressurizing section 243 is equipped with a pressurizing roller 243a and a pushing section 243b. The pressurizing section 243 applies a pressurizing force to the fixing belt 242 from the inner peripheral side thereof to form the nip section N between the heating roller 241 and the fixing belt 242.

The pressurizing roller 243a is provided at a position corresponding to the downstream portion of the nip section N in the sheet conveying direction X. The pressurizing roller 243a has higher hardness than the first, second, and third pads constituting the pushing section 243b, and is composed of cylindrical cored bar formed of metal such as aluminum, iron and alloy, or the like, for example.

The pressurizing roller 243a pressures the fixing belt 242 from the inner peripheral side thereof so that the periphery surface of the fixing belt 242 is pressed to the nip section N, and supports the fixing belt 242.

The pushing section 243b is composed of: the first pad 243b1; the second pad 243b2; the third pad 243b3; a compression spring (not shown) supporting a holding member 243b4 and applying a pressurizing force thereto; a holder to store the above members (not shown); a movably contacting sheet (not shown) to cover upper surfaces of the first and third pads and to movably contact with an inner periphery of the fixing belt 242; and so on.

The first pad 243b1 and the second pad 243b2 form a member layer in which these pads are laminated in a perpendicular direction with respect to the sheet conveying direction X, and the member layer is provided at the position corresponding to the upstream portion of the nip section in the sheet conveying direction X. The first pad 243b1 as the closest layer (upper layer) to the nip section has lower hardness than the second pad 243b2 as the farthest layer (lower layer) from the nip section.

The hardness of whole member layer is higher than that of the first pad, and is equal to or less than that of the second pad. For example, by forming the first pad 243b1 using a sponge having heat resistance property, and by forming the second pad 243b2 using urethane having heat resistance property, it becomes possible to make the hardness of the whole member layer higher than the hardness of the first pad 243b1 and equal to or less than the hardness of the second pad 243b2.

The third pad 243b3 is provided at a position corresponding to the central portion of the nip section along the sheet conveying direction X, namely provided between the member layer composed of the first and second pads 243b1, 243b2 and the pressurizing roller 243a. The third pad 243b3 has lower hardness than that of the whole member layer composed of the first and second pads 243b1, 243b2. The third pad 243b3 is formed by using elastic material such as silicon rubber having heat resistance property, for example.

The holding member 243b4 is composed of a metal plate such as stainless holding the first, second, and third pads, and a resin plate supporting the metal plate. Thus, the holding member 243b4 is composed of rigid material which can maintain strength not to be damaged even when elastic force is applied by the compression spring.

The elastic force of the compression spring is applied to the fixing belt 242 as a certain pressurizing force through the holding member 243b4 and the first, second, and third pads.

Here, a distribution of the pressurizing force inside the nip section in the sheet conveying direction X will be described.

As described above, the pressurizing section 243 is composed of: the member layer composed of the first and second pads, which layer is provided at the position corresponding to the upstream portion of the nip section along the sheet conveying direction X; the third pad provided at the position corresponding to the central portion; and the pressurizing roller provided at the position corresponding to the downstream portion, and these members have different hardnesses from one another. According to the abovementioned configuration, the relation among the hardness H1 of the whole member layer composed of the first and second pads, the hardness H2 of the third pad, and the hardness H3 of the pressurizing roller becomes as described below.

H3>H1>H2

The upstream portion of the nip section in the sheet conveying direction X receives the pressurizing force from the member layer composed of the first and second pads. The downstream portion of the nip section in the sheet conveying direction X receives the pressurizing force from the pressurizing roller. The central portion of the nip section in the sheet conveying direction X receives the pressurizing force from the third pad. Thus, the distribution of the pressurizing force inside the nip section in the sheet conveying direction X becomes as described below.

P3>P1>P2

P1: pressurizing force on upstream side of nip section in sheet conveying direction X

P2: pressurizing force in central portion of nip section in sheet conveying direction X

P3: pressurizing force on downstream side of nip section in sheet conveying direction X

By the above configuration, the pressurizing section 243 applies the pressurizing force to the upstream and downstream portions of the nip section, which pressurizing force is higher than that of the central portion of the nip section, and applies the pressurizing force to the downstream portion of the nip section, which pressurizing force is higher than that of the upstream portion, along the sheet conveying direction X.

### EXAMPLES

Hereinafter, the fixing device according to the embodiment will be described in detail by citing examples. The embodiment of the present invention is not limited to these examples.

In this example, in the image forming apparatus shown in FIG. 1, by using a plurality of fixing devices whose configurations of the first, second, and third pads are different from one another, pressure distributions in the respective nip sections were performed, and the images after fixing process were observed to evaluate image qualities.

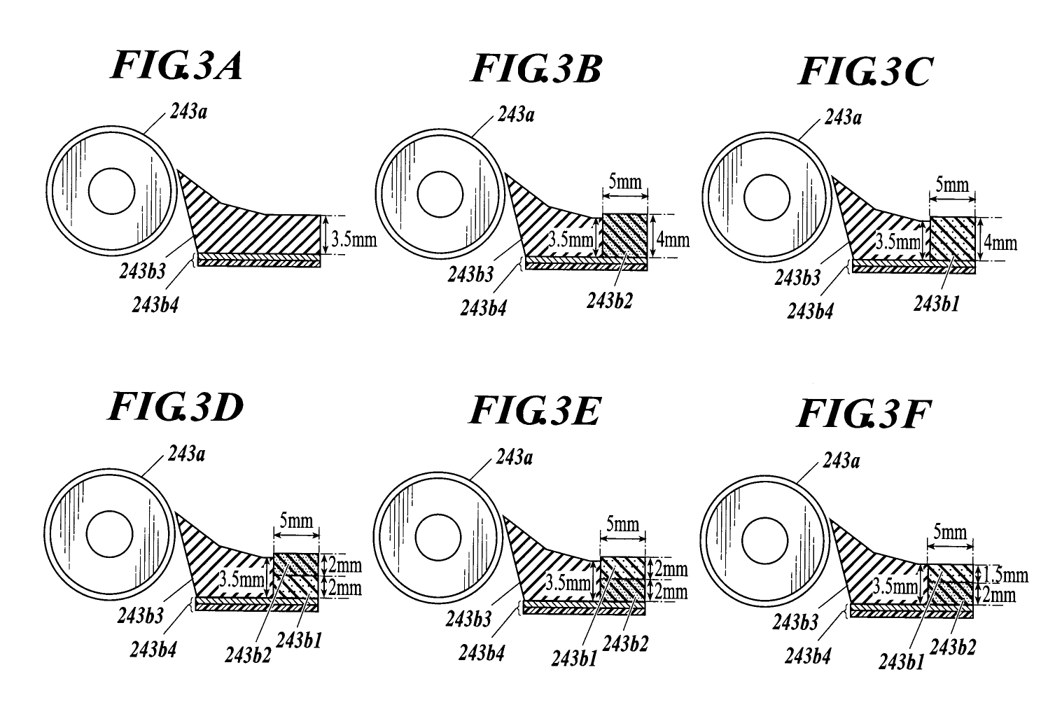

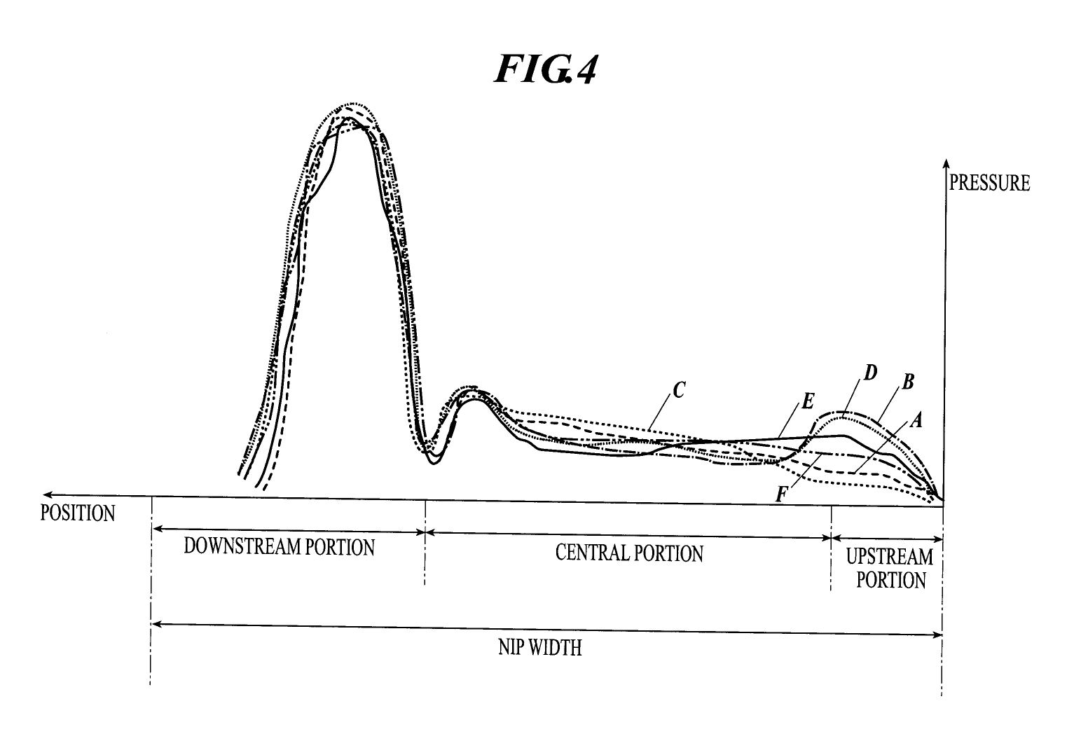

FIGS. 3A-3F show the schematic configuration diagrams of the pressurizing sections in which the first, second, and third pads have different configurations from one another, and FIG. 4 shows pressure distributions in the nip sections of the fixing devices respectively equipped with the pressurizing sections shown in FIGS. 3A-3F. The length of the upstream portion of the nip section in the sheet conveying direction was 15% (5 [mm] in this example) of the nip width.

Table 1 shows results of image quality evaluation by using the fixing devices (patterns A-F) respectively equipped with the pressurizing sections shown in FIGS. 3A-3F. Overall judgment was made based on results of observation by visually judgment of presence or absence of image misalignment or other noises such as uneven brightness and wrinkles. An evaluation criterion of each item is as described below.

G: Without image misalignment, without other noises, no problem was found as a result of overall judgment.

NG: With image misalignment, with other noises, some problems were found as a result of overall judgment.

TABLE 1

| | IMAGE | | OVERALL |
|---|---|---|---|
| PATTERN | MISALIGNMENT | OTHER NOISES | JUDGMENT |
| A | NG | G | NG |
| B | G | NG | NG |
| C | NG | G | NG |
| D | G | NG | NG |
| E | G | G | G |
| F | NG | G | NG |

FIG. 3A shows an example of the pressurizing section 243 in which the third pad is provided correspondingly to the upstream and central portions inside the nip section in the sheet conveying direction. The pressurizing section 243 shown in FIG. 3A is composed of: the pressurizing roller 243a; and the pushing section 243b including the third pad 243b3, the holding member 243b4, the compression spring (not shown), the holder (not shown), and the movably contacting sheet (not shown).

The third pad 243b3 of FIG. 3A is formed by using silicon rubber (hardness: JIS-A20°), and the thickness of the third pad 243b3 before receiving the pressurizing force from the compression spring is 3.5 [mm].

The pressure distribution in the nip section of the fixing device equipped with the pressurizing section shown in FIG. 3A is curve A shown in FIG. 4. As shown as curve A, the pressure in the downstream portion of the nip section in the sheet conveying direction is highest. For this reason, a sheet discharging force can be ensured.

As shown in curve A of FIG. 4, the pressure in the upstream portion of the nip section in the sheet conveying direction is lower than the central portion. As a result, the sheet could not be held in the upstream portion of the nip section, and sheet behavior inside the nip section became unstable so that image misalignment occurred.

Thus, as shown in Table 1, according to the fixing device (pattern A) equipped with the pressurizing section shown in FIG. 3A, image misalignment occurred and problems were found in image quality.

FIG. 3B shows an example of the pressurizing section 243 in which the member layer composed of the second pad is provided correspondingly to the upstream portion in the nip section in the sheet conveying direction, and the third pad is provided correspondingly to the central portion in the nip section. The pressurizing section 243 shown in FIG. 3 is composed of the pressurizing roller 243a, and the pushing section 243b including the second pad 243b2, the third pad 243b3, the holding member 243b4, the compression spring (not shown), the holder (not shown), and the movably contacting sheet (not shown).

The second pad 243b2 of FIG. 3B is formed by using urethan (hardness: JIS-70°), and the thickness of the second pad 243b2 before receiving the pressurizing force from the compression spring is 4 [mm]. The third pad 243b3 of FIG. 3B is formed by using silicon rubber (hardness: JIS-A20°), and the thickness of the third pad 243b3 before receiving the pressurizing force from the compression spring is 3.5 [mm].

The pressure distribution in the nip section of the fixing device equipped with the pressurizing section shown in FIG. 3B is curve B shown in FIG. 4. As shown as curve B, the pressure in the downstream portion of the nip section in the sheet conveying direction is highest. For this reason, a sheet discharging force can be ensured.

As shown in curve B of FIG. 4, the pressure in the upstream portion of the nip section in the sheet conveying direction is higher than that of the central portion. This is probably because since the hardness of the second pad is higher than that of the third pad and the second pad deforms less than the third pad when receiving the pressurizing force from the compression spring, the second pad can transmit the pressurizing force to the inner peripheral surface of the fixing belt more efficiently than the third pad. However, because a pressure difference between the upstream portion and the central portion of the nip section in the sheet conveying direction was large, a solution rate of the un-fixed toner image in the upstream portion of the nip section becomes different from that of the central portion, and noises such as uneven brightness and sheet wrinkles occurred.

Thus, as shown in Table 1, according to the fixing device (pattern B) equipped with the pressurizing section shown in FIG. 3B, the other noises occurred and problems were found in image quality.

FIG. 3C shows an example of the pressurizing section 243 in which the member layer composed of the first pad is provided correspondingly to the upstream portion in the nip section in the sheet conveying direction, and the third pad is provided correspondingly to the central portion in the nip section. The pressurizing section 243 shown in FIG. 3C is composed of the pressurizing roller 243a, and the pushing section 243b including the first pad 243ba, the third pad 243b3, the holding member 243b4, the compression spring (not shown), the holder (not shown), and the movably contacting sheet (not shown).

The first pad 243b1 of FIG. 3C is formed by using sponge (density: 260 [kg/m³], 25 percent compression load: 0.034 [MPa]), and the thickness of the first pad 243b1 before receiving the pressurizing force from the compression spring is 4 [mm]. The third pad 243b3 of FIG. 3C was formed similarly to the case of FIG. 3B.

The pressure distribution in the nip section of the fixing device equipped with the pressurizing section shown in FIG. 3C is curve C shown in FIG. 4. As shown as curve C, the pressure in the downstream portion of the nip section in the sheet conveying direction is highest. For this reason, a sheet discharging force can be ensured.

As shown in curve C of FIG. 4, the pressure in the upstream portion of the nip section in the sheet conveying direction is higher than that of the central portion. This is probably because since the hardness of the first pad is lower than that of the third pad and the first pad deforms more than the third pad when receiving the pressurizing force from the compression spring, the first pad transmits the pressurizing force to the inner peripheral surface of the fixing belt less than the third pad. For this reason, the sheet cannot be held in the upstream portion of the nip section, and sheet behavior inside the nip section became unstable so that image misalignment occurred.

Thus, as shown in Table 1, according to the fixing device (pattern C) equipped with the pressurizing section shown in FIG. 3C, image misalignment occurred and some problems were found in image quality.

FIG. 3D shows an example of the pressurizing section 243 in which the member layer composed of the first and second pads is provided correspondingly to the upstream portion in the nip section in the sheet conveying direction, and the third pad is provided correspondingly to the central portion in the nip section. The pressurizing section 243 shown in FIG. 3D is composed of the pressurizing roller 243a, and the pushing section 243b including the first, second, and third pads 243b1, 243b2, 243b3, the holding member 243b4, the compression spring (not shown), the holder (not shown), and the movably contacting sheet (not shown).

The member layer shown in FIG. 3D has a configuration where the second pad 243b2 is provided in the closest layer (upper layer) to the nip section, and the first pad 243b1 is provided in the farthest layer (lower layer) from the nip section.

The first pad 243b1 of FIG. 3D is formed by using sponge (density: 260 [kg/m³], 25 percent compression load: 0.034 [MPa]), and the thickness of the first pad 243b1 before receiving the pressurizing force from the compression spring is 2 [mm]. The second pad 243b2 of FIG. 3D is formed by using urethan (hardness: JIS-70°), and the thickness of the second pad 243b2 before receiving the pressurizing force from the compression spring is 2 [mm]. Thus, the thickness of the member layer becomes 4 [mm].

The third pad 243b3 of FIG. 3D was formed similarly to the case of FIG. 3B.

The pressure distribution in the nip section of the fixing device equipped with the pressurizing section shown in FIG. 3D is curve D shown in FIG. 4. As shown as curve D, the pressure in the downstream portion of the nip section in the sheet conveying direction is highest. For this reason, a sheet discharging force can be ensured.

As shown in curve D of FIG. 4, the pressure in the upstream portion of the nip section in the sheet conveying direction is higher than that of the central portion. This is probably because the hardness of the first pad which transmits the pressurizing force from the compression spring to the second pad is lower than that of the third pad, and the hardness of the second pad is higher than that of the third pad. In other words, this is probably because while when receiving the pressurizing force from the compression spring, the first pad deforms more than the third pad and transmits the pressurizing force to the second pad less efficiently than the configuration of FIG. 3B, the second pad deforms less than the third pad and can transmit the pressurizing force to the inner peripheral surface of the fixing belt more efficiently than the third pad. However, as shown in curve D, since a pressure difference between the upstream portion and the central portion in the nip section in the sheet conveying direction was large, a solution rate of the un-fixed toner image in the upstream portion of the nip section becomes different from that of the central portion, and other noises such as uneven brightness and sheet wrinkles occurred.

Thus, as shown in Table 1, according to the fixing device (pattern D) equipped with the pressurizing section shown in FIG. 3D, the other noises occurred and some problems found in image quality.

FIG. 3E shows an example of the pressurizing section 243 in which the member layer composed of the first and second pads is provided correspondingly to the upstream portion in the nip section in the sheet conveying direction, and the third pad is provided correspondingly to the central portion in the nip section. The pressurizing section 243 is composed of the pressurizing roller 243a, and the pushing section 243b including the first, second, and third pads 243b1, 243b2, 243b3, the holding member 243b4, the compression spring (not shown), the holder (not shown), and the movably contacting sheet (now shown).

The member layer shown in FIG. 3E has a configuration where the first pad 243b1 is provided in the closest layer (upper layer) to the nip section, and the second pad 243b2 is provided in the farthest layer (lower layer) to the nip section.

The first, second, and third pads 243b1, 243b2, 243b3 of FIG. 3E were formed similarly to the case of FIG. 3D.

The pressure distribution in the nip section of the fixing device equipped with the pressurizing section shown in FIG. 3E is curve E shown in FIG. 4. As shown as curve E, the pressure in the downstream portion of the nip section in the sheet conveying direction is highest. For this reason, a sheet discharging force can be ensured.

As shown in curve E of FIG. 4, the pressure in the upstream portion of the nip section in the sheet conveying direction is higher than that of the central portion. This is probably because the hardness of the second pad which transmits the pressurizing force from the compression spring to the first pad is higher than that of the third pad, and the hardness of the first pad is lower than that of the third pad. In other words, this is probably because when receiving the pressurizing force from the compression spring, the second pad deforms less than the third pad and can transmit the pressurizing force to the first pad more efficiently than the third pad, and the first pad deforms more than the third pad and can transmit the pressurizing force while increasing adhesion to the inner peripheral surface of the fixing belt. As a result, the pressurizing force in a scanning direction becomes even in the upstream portion of the nip section in the sheet conveying direction, and the sheet in the upstream portion of the nip section can be held evenly in the scanning section so that sheet behavior inside the nip section becomes stable.

Thus, as shown in Table 1, according to the fixing device (pattern E) equipped with the pressurizing section shown in FIG. 3E, image misalignment or other noise did not occur, and no problem was found in image quality.

FIG. 3F shows an example of the pressurizing section 243 obtained by making the thickness of the first pad 243b1 before receiving the pressurizing force from the compression spring be 1.5 [mm] and making the thickness of the member layer be 3.5 [mm] in the pressurizing section 243 shown in FIG. 3E.

The pressure distribution in the nip section of the fixing device equipped with the pressurizing section shown in FIG. 3F is curve F shown in FIG. 4. As shown as curve F, the pressure in the downstream portion of the nip section in the sheet conveying direction is highest. For this reason, a sheet discharging force can be ensured.

As shown by curve F of FIG. 4, the pressure in the upstream portion of the nip section in the sheet conveying direction is lower than that of the central portion. This is probably because since the thickness of the member layer is equal to the thickness (3.5 [mm]) of the third pad, when receiving pressurizing force from the compression spring, the first pad deforms less than the third pad so that the first pad cannot increase the adhesion force to the inner peripheral surface of the fixing belt as transmitting the pressurizing force. Thus, the sheet could not be held in the upstream portion of the nip section, and sheet behavior was unstable inside the nip section so that image misalignment occurred.

Thus, as shown in Table 1, according to the fixing device (pattern F) equipped with the pressurizing section shown in FIG. F, image misalignment occurred and some problems were found in image quality.

Therefore, it was found that the fixing device shown in FIG. E can achieve the best image quality, which fixing device is composed of materials having different hardnesses from one another, the materials respectively corresponding to the upstream portion, central portion, and downstream portion of the nip section in the sheet conveying direction, and which fixing device is equipped with the pressurizing section 243 to add the pressurizing force which is higher in the downstream portion than the upstream portion and the and central portion, and higher in the upstream portion than the central portion, inside the nip section in the sheet conveying direction.

As described above, according to the embodiment, the higher pressurizing force can be applied to the upstream and down stream portions than the central portion of the nip section in the sheet conveying direction, and the higher pressurizing force can be applied to the downstream portion than the upstream portion of the nip section. As a result, the sheet can be held in the upstream portion of the nip section in the sheet conveying direction, and the sheet discharging force can be ensured in the downstream portion. Thus, unevenness of sheet conveying speed in the nip section can be reduced, and sheet behavior inside the nip section can be stabilized.

Therefore, image failures such as image misalignment in the nip section and other noise including uneven brightness and sheet wrinkles can be prevented from occurring so that fixing accuracy can be improved.

Moreover, since in the upstream portion of the nip section in the sheet conveying direction the pressurizing section 243 has the member layer including a plurality of layers laminated in the perpendicular direction to the sheet conveying direction, and since the closest layer (first pad 243b1) to the nip section among the plurality of layers constituting the member layer has the lower hardness than that of the farthest layer (second pad 243b2) from the nip section, the pressurizing force in the scanning direction becomes even in the upstream portion of the nip section in the sheet conveying direction, and the sheet in the upstream portion of the nip section can be held evenly so that sheet behavior inside the nip section can be stabilized.

Furthermore, since the pressurizing section 243 is composed of the members (the member layer composed of the first and second pads, the third pad, and the pressurizing roller) having different hardnesses from one another, the members respectively corresponding to the upstream, central, and downstream portions of the nip section in the sheet conveying direction, and since the member (pressurizing roller 243a) corresponding to the downstream portion has the highest hardness, the pressurizing force to the downstream portion can be made to be the highest, and the sheet discharging force from the nip section can be ensured.

The present invention is not limited to the contents of the above embodiment and can be appropriately changed without departing from the subject matter of the present invention.

According to one aspect of the embodiment, there is provided a fixing device including: a heating section; a pressure contact section to form a nip section with the heating device and to pressure a sheet so that the sheet contacts with the heating section; and a pressurizing section to add a pressurizing force to the sheet through the pressure contact section and to make the nip section be formed between the heating section and the pressure contact section; wherein the pressurizing section adds the higher pressurizing force to an upstream portion and a downstream portion of the nip section than the pressurizing force added to a central portion of the nip section in a sheet conveying direction, and adds the higher pressurizing force to the downstream portion than the pressurizing force added to the upstream portion.

According to one aspect of the embodiment, there is provided an image forming apparatus including: an image forming section to form a toner image on an image carrier with a toner; a sheet conveying section to convey a sheet; a transferring section to transfer the toner image on the image carrier on the sheet conveyed by the sheet conveying section; and a fixing device to fix the toner image transferred on the sheet, wherein the fixing device including: a heating section; a pressure contact section to form a nip section with the heating device and to pressure the sheet so that the sheet contacts with the heating section; and a pressurizing section to add a pressurizing force to the sheet through the pressure contact section and to make the nip section be formed between the heating section and the pressure contact section, and the pressurizing section adds the higher pressurizing force to an upstream portion and a downstream portion of the nip section than the pressurizing force added to a central portion of the nip section in a sheet conveying direction, and adds the higher pressurizing force to the downstream portion than the pressurizing force added to the upstream portion.

In the fixing device and the image forming apparatus, the sheet can be held in the upstream portion of the nip section in the sheet conveying direction, and the sheet discharging force can be ensured in the downstream portion. Thus, unevenness of sheet discharging speed can be reduced inside the nip section, and sheet behavior inside the nip section can be stabilized. Therefore, image failures such as image misalignment in the nip section and sheet wrinkles can be reduced so that fixing accuracy can be improved.

Preferably, the pressurizing section including: a pressurizing roller provided at a position corresponding to the downstream portion of the nip section in the sheet conveying direction, and a pushing member provided at a position corresponding to the upstream portion of the nip section in the sheet conveying direction.

Preferably, the pushing member includes a member layer in which a plurality of layers are laminated in a perpendicular direction with respect to the sheet conveying direction at a position corresponding to the upstream portion of the nip section in the sheet conveying direction, and among the plurality of layers constituting the member layer, a closest layer to the nip section has lower hardness than a farthest layer from the nip section.

By this, the pressurizing force in the scanning direction becomes even in the upstream portion of the nip section in the sheet conveying direction, the sheet in the upstream portion of the nip section can be held evenly so that sheet behavior inside the nip section can be stabilized.

Preferably, the pushing member is composed of members having different hardnesses from one another, the members respectively corresponding to the upstream portion, the central portion, and the downstream portion of the nip section in the sheet conveying direction, and among the members, a member corresponding to the downstream portion has the highest hardness.

By this, the pressurizing force to the downstream portion can be highest, and the sheet discharging force from the nip section can be ensured.

Preferably, the pressurizing section has a belt-like shape.

The present U.S. patent application claims a priority under the Paris Convention of Japanese patent application No. 2009-234008 filed on 8 Oct. 2009, which shall be a basis of correction of an incorrect translation.

What is claimed is:

1. A fixing device comprising:
a heating section;
a pressure contact section to form a nip section with the heating device and to pressure a sheet so that the sheet contacts with the heating section; and
a pressurizing section to add a pressurizing force to the sheet through the pressure contact section and to make the nip section be formed between the heating section and the pressure contact section;
wherein the pressurizing section adds the higher pressurizing force to an upstream portion and a downstream portion of the nip section than the pressurizing force added to a central portion of the nip section in a sheet conveying direction, and adds the higher pressurizing force to the downstream portion than the pressurizing force added to the upstream portion.

2. The fixing device of claim 1, wherein the pressurizing section including:
a pressurizing roller provided at a position corresponding to the downstream portion of the nip section in the sheet conveying direction, and
a pushing member provided at a position corresponding to the upstream portion of the nip section in the sheet conveying direction.

3. The fixing device of claim 2, wherein
the pushing member includes a member layer in which a plurality of layers are laminated in a perpendicular direction with respect to the sheet conveying direction at a position corresponding to the upstream portion of the nip section in the sheet conveying direction, and
among the plurality of layers constituting the member layer, a closest layer to the nip section has lower hardness than a farthest layer from the nip section.

4. The fixing device of claim 2, wherein
the pushing member is composed of members having different hardnesses from one another, the members respectively corresponding to the upstream portion, the central portion, and the downstream portion of the nip section in the sheet conveying direction, and
among the members, a member corresponding to the downstream portion has the highest hardness.

5. The fixing device of claim 1, wherein the pressurizing section has a belt-like shape.

6. An image forming apparatus comprising:
an image forming section to form a toner image on an image carrier with a toner;
a sheet conveying section to convey a sheet;
a transferring section to transfer the toner image on the image carrier on the sheet conveyed by the sheet conveying section; and
a fixing device to fix the toner image transferred on the sheet, wherein
the fixing device including:
a heating section;
a pressure contact section to form a nip section with the heating device and to pressure the sheet so that the sheet contacts with the heating section; and
a pressurizing section to add a pressurizing force to the sheet through the pressure contact section and to make the nip section be formed between the heating section and the pressure contact section, and
the pressurizing section adds the higher pressurizing force to an upstream portion and a downstream portion of the nip section than the pressurizing force added to a central portion of the nip section in a sheet conveying direction, and adds the higher pressurizing force to the downstream portion than the pressurizing force added to the upstream portion.

7. The image forming apparatus of claim 6, wherein the pressurizing section including:
a pressurizing roller provided at a position corresponding to the downstream portion of the nip section in the sheet conveying direction, and
a pushing member provided at a position corresponding to the upstream portion of the nip section in the sheet conveying direction.

8. The image forming apparatus of claim 7, wherein
the pushing member includes a member layer in which a plurality of layers are laminated in a perpendicular direction with respect to the sheet conveying direction at a position corresponding to the upstream portion of the nip section in the sheet conveying direction, and
among the plurality of layers constituting the member layer, a closest layer to the nip section has lower hardness than a farthest layer from the nip section.

9. The image forming apparatus of claim 7, wherein
the pushing member is composed of members having different hardnesses from one another, the members respectively corresponding to the upstream portion, the central portion, and the downstream portion of the nip section in the sheet conveying direction, and
among the members, a member corresponding to the downstream portion has the highest hardness.

10. The image forming apparatus of claim 6, wherein the pressurizing section has a belt-like shape.
